(19) United States
(12) Patent Application Publication
(10) Pub. No.: US 2005/0232126 A1
(43) Pub. Date: Oct. 20, 2005

(54) Optical data storage medium and use of such medium

(75) Inventors: Andrei Mijiritskii, Eindhoven (NL); Joachim Wilhelm Hellmig, Eindhoven (NL); Hermanus Johannes Borg, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., 5621 BA Eindhoven (NL)

(21) Appl. No.: 10/517,542

(22) PCT Filed: Jun. 11, 2003
(86) PCT No.: PCT/IB03/02572

§ 371 Date: Dec. 10, 2004

(30) Foreign Application Priority Data
Jun. 14, 2002 (EP) 02077442.8

(51) Int. Cl. G11B 7/00

(52) U.S. Cl. 369/125

(57) ABSTRACT

An optical data storage medium (10) is described for read out using a focused radiation beam (19) with a wavelength λ sand a Numerical Aperture NA. The medium has a substrate (11) and a first stack of layers named L0 (12) comprising a first information layer and optionally at least one further stack of layers named Ln (13), comprising a further information layer. A radiation beam (19) transparent spacer layer (14) is present between each of L0 and Ln. A transmission stack named TS0 with a thickness dTS0 contains all layers between L0 (12) and an entrance face (16) of the medium (10). A transmission stack named TSn with a thickness dTSn contains all layers between Ln (13) and the entrance face (16). The maximum deviation of dTS0 and when applicable dTSn does not exceed a predetermined value DEVdTS0 or DEVdTSn, measured over the information area of the medium (10) and this value is set in dependency of λ and NA. In this way a reliable read out of the information layer(s) without the need for dynamic spherical aberration correction is achieved.

The invention relates to an optical data storage medium for at least read out using a focused radiation beam with a wavelength λ and a Numerical Aperture (NA), entering through an entrance face of the medium during read out, comprising at least:
a substrate with present on a side thereof:
a first stack of layers named L0 comprising a first information layer,
a radiation beam transparent cover layer adjacent the entrance face,
a transmission stack named TS0 with a thickness d_{TS0} and containing all layers between L0 and the entrance face.

The invention also relates to the use of such medium.

An embodiment of such an optical recording medium is known from a paper “New Replication Process Using Function-assigned Resins for Dual-layered Disc with 0.1 mm thick Cover layer”, by K. Hayashi, K. Hisada and E. Ohno, Technical Digest ISOM 2001, Taipei, Taiwan.

There is a constant drive for obtaining optical storage media suitable for recording and reproducing, which have a storage capacity of 8 Gigabyte (GB) or larger. This requirement is met by some Digital Video Disk or sometimes also Digital Versatile Disk formats (DVD). DVD formats can be divided into DVD-ROM that is exclusively for reproduction, DVD-RAM, DVD−RW and DVD+RW, which are also usable for rewritable data storage, and DVD-R, which is recordable once. Presently the DVD formats comprise disks with capacities of 4.7 GB, 8.5 GB, 9.4 GB and 17 GB.

The 8.5 GB and, in particular, the 9.4 GB (DVD-9) and 17 GB (DVD-18) formats exhibit more complicated constructions and usually comprise multiple information storage layers. The 4.7 GB single layer re-writable DVD format is easy to handle comparable, for example, to a conventional compact disk (CD) but offers an insufficient storage capacity for video recording purposes.

A high storage capacity format that recently has been suggested is Digital Video Recording (DVR). Two formats are currently being developed: DVR-red and DVR-blue, the latter also called Blu-ray Disc (BD), where red and blue refer to the used radiation beam wavelength for recording and reading. This disk overcomes the capacity problem and, in its simplest form, has a single storage layer format which is suitable for high density digital video recording and storage having a capacity up to 22 GB or more in the DVR-blue format.

The DVR disk generally comprises a disk-shaped substrate exhibiting on one or both surfaces an information storage layer. The DVR disk further comprises one or more radiation beam transmissive layers. These layers are transmissive to the radiation beam that is used to read from or write into the disk. For example a transmissive cover layer, which is applied on the information storage layer. Generally, for high-density disks, lenses with high numerical aperture (NA), e.g. higher than 0.60, are used for focusing such a radiation beam with a relatively low wavelength. For systems with NA's above 0.60 it becomes increasingly difficult to apply substrate incident recording with substrate thicknesses in the 0.6-1.2 mm range due to decreasing tolerances on e.g. thickness variations and disk tilt. For this reason, when using disks that are recorded and read out with a high NA, focusing onto a recording layer of a first recording stack, is performed from the side opposite from the substrate. Because the first recording layer has to be protected from the environment at least one relatively thin radiation beam transmissive cover layer, e.g. thinner than 0.5 mm, is used through which the radiation beam is focused. Clearly the need for the substrate to be radiation beam transmissive no longer exists and other substrate materials, e.g. metals or alloys thereof, may be used.

A dual-stack optical data storage medium has two reflective information layers, that are read-out from the same side of the medium. In this dual stack medium case, where a second recording stack is present, a radiation beam transmissive spacer layer is required between the recording stacks. The further recording stack must be at least partially transparent to the radiation beam wavelength in order to make reading from the first information layer of the first recording stack possible. The thickness of the spacer layers is chosen such that the information layers are optically decoupled from each other. In this case, the laser beam can be focused on each storage layer individually and no signal interference with other storage layers occurs. The radiation beam transmissive layer or layers which are present between the radiation beam source and the recording stack that is most remote from the substrate are normally called cover layers. When prefabricated sheets are used as transmissive layers extra transmissive adhesive layers are required in order to bond cover layers to each other.

In the DVR disk the variation or unevenness of the thickness of the radiation beam transmissive layers over the radial extension of the disk has to be controlled very carefully in order to minimize the variation in the optical path length for the impinging radiation. Especially the optical quality of the radiation beam at the focal point in the BD or DVR-blue version, which uses a radiation beam with a wavelength substantially equal to 405 nm and an NA substantially equal to 0.85, is relatively sensitive to variations in the thickness of the transmissive layers. The total layer thickness has an optimal value in order to obtain minimum optical spherical aberration of the focused radiation beam on, e.g., the first information recording layer. A deviation, e.g. ∓5 μm from this optimal thickness already introduces a considerable and unacceptable amount of this kind of aberration. Depending on the system the spacer layer thickness can be in the range from a few μm to about 100 μm. Besides, the disk can also have a cover layer. Such layers are usually made by using plastic foils or by spin-coating resin layers. Other manufacturing processes can also be employed. These technological processes result in thickness variations of the spacer/cover layers. This is especially true for the variations in the radial direction of the disk, in particular if the spin-coating process is applied. As a result the depth position of the information layers with respect to the entrance surface of the disk and the distance between the information layers can vary significantly within a disk. Such variations cause additional spherical aberrations in the system resulting in poor signal quality, delays in jumping between the information layers, and can eventually lead to malfunction of the system. For successful read-out and writing sharp focusing should be possible on each of the information layers in the disk. Therefore, the additional spherical aberrations caused by the spacer/cover layer variations should be corrected for by the optical drive. If the variations are sufficiently small and fall within the focusing range of the actuator, they can be corrected by the actuator itself. If the variations are larger than the working range of the actuator, dynamic spherical aberration correction has to be employed or other servo methods have to be introduced into the system.

As said above, mass manufactured single-stack and multi-stack optical data storage media possess thickness variations of the spacer/cover layers. Due to these variations depth positions of the information layers deviate from the predefined values. If such deviations are too large for the focusing system to cope with, deterioration of the servo and data signals takes place leading to poor system performance. A solution to compensate for the large depth position deviations in the disk could be dynamic spherical aberration (SA) correction unit in the optical pick up unit (OPU) in the optical drive. The disadvantage of this method is the necessity to continuously generate a SA error signal.

It is an object of the invention to provide a medium of the kind as described in the opening paragraph with a reliable read out of data from the information layer(s).

This object is achieved in accordance with the invention by an optical data storage medium which is characterized in that the maximum deviation of d_{TS0} from respectively the average values of d_{TS0} of a predetermined area of the medium does not exceed a predetermined value DEVd_{TS0}, measured over the whole area of the medium and DEVd_{TS0} is set in dependency of λ and NA.

In this way a medium layout is achieved for which no dynamic spherical aberration (SA)-correction is necessary for correct focussing and a reliable read out of data Dynamic SA correction would be required when the maximum deviation is exceeded. But according to the invention no substantial correction for spherical aberration is required when the first information layer of the medium of the medium is scanned by the optical medium drive. During scanning the OPU will move radially inward or radially outward while the medium rotates. When the thickness variations of TS0 is within said limit also the spherical aberration stays within acceptable limit over the information area of the medium. A thickness variation of the transmission stack mainly induces spherical aberration A40. The spherical aberration leads to a wavefront error. For correct focusing of the radiation beam the wavefront rms error should not exceed 0.033 λ Calculations show that the wavefront error strongly depends on the NA of the radiation beam, the thickness d and refractive index n of the transmission stack through which the focused radiation beam travels, and λ since the error is expressed in units of λ. The general formula for A40 is:

$$A40 = \frac{( {n}^{2} - 1 )}{8 {n}^{3}} {d ( NA )}^{4}$$

Normally, in an optical disk system the aberration at a predetermined thickness d is cancelled by the objective that has been designed to introduce the same amount of spherical aberration with opposite sign. So in practice problems only arise when the thickness d deviates from its predetermined value by an amount of Δd and d in the formula should be read accordingly. The maximum allowable Δd may be translated to DEVd_{TS0}.

In an embodiment DEVd_{TS0}=±3 μm. Especially in the case of media using a short radiation beam wavelength λ of e.g. smaller than 500 nm and a high NA of e.g. larger than 0.75, this value should be kept within said limits.

In a favorable embodiment the medium has at least
one further stack of layers named Ln and n an integer ≦1, Ln comprising a further information layer and being present at a position closer to the entrance face than L0,
a radiation beam transparent spacer layer between each of L0 to Ln, and
a transmission stack named TSn with a thickness d_{TSn} and containing all layers between Ln and the entrance face, wherein the maximum deviation of d_{TSn} does not exceed a predetermined value DEVd_{TSn}, measured over the whole area of the medium and DEVd_{TSn} is set in dependency of λ and NA. Introducing further recording levels Ln enhances the storage capacity of the medium. The stack Ln must be at least partially transparent to the radiation beam in order to make reading and writing in the L0 stack possible. Again especially in the case of media using a short radiation beam wavelength λ of e.g. smaller than 500 nm and a high NA of e.g. larger than 0.75, this value DEVd_{TSn} should preferably be kept within ±3 μm. In case such a multi stack medium is used the only instance when spherical aberration correction is required is when the OPU switches between focusing onto one information layer to another information layer. This correction is performed in the OPU with special means and does not have to be dynamic.

Preferably DEVd_{TS0}=±2 μm. Keeping in mind possible medium deformations caused by the manufacturing and working conditions (temperature, humidity, etc.) the depth position variations of the storage layers should rather be smaller than ±2 μm.

In a special embodiment only one further stack of layers named L1 is present, comprising a further information layer, DEVd_{TS1}=±2 μm, λ is in the range 400 nm-4101 nm and NA is in the range 0.84-0.86. These values apply for the Blu-ray Disc (BD) that was discussed earlier in which case reliable read out is possible without dynamic SA correction. The BD comprises two transmission stacks TS0 and TS1 with effective refractive indices n_{TS0} and n_{TS1} and thicknesses d_{TS0} and d_{TS1}. In the BD n_{TS0} and n_{TS1} both have a value of 1.6 or close hereto and the following conditions are fullfilled: 95 μm≦d_{TS0}≦105 μm and 70 μm≦d_{TS1}≦80 μm. Most plastic materials used as transparent layers have a refractive index of 1.6 or substantially close hereto. The layer between L0 and L1 is called spacer layer and the layer between L1 and the entrance face is called cover layer.

In a further embodiment the spacer layer thickness is 20 μm or substantially close to 20 μm and the cover layer thickness is 80 μm or substantially close to 80 μm. It is advantageous from a viewpoint of manufacture to use a substantial fixed value of the spacer and cover layer thickness. For instance, one method of manufacture comprises the application of a sheet including a pressure sensitive adhesive (PSA), which is UV-cured after being brought in contact with other layers of the medium. This material is usually supplied as a sheet of foil with the PSA on one or both sides and those sheets are made with a predetermined thickness. In the BD the spacer layer thickness is between 20 μm and 30 μm and the cover layer thickness should be adjusted accordingly, e.g. between 80 μm and 70 μm.

The invention will be elucidated in greater detail with reference to the accompanying drawings in which

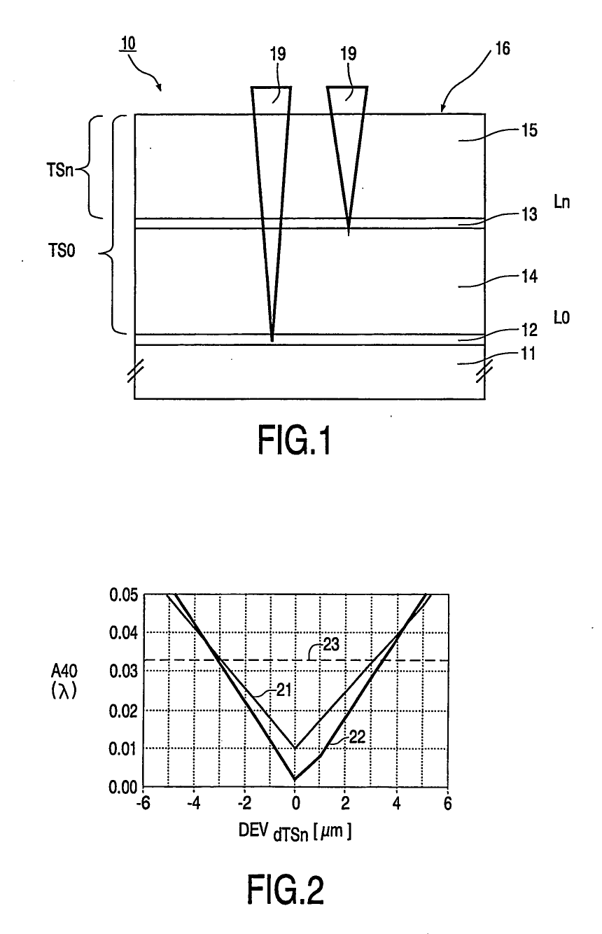

FIG. 1 schematically shows the layout of an optical data storage medium according to the invention having two information layers (Ln=L1).

FIG. 2 shows the calculated wavefront error rms as a function of the depth position deviation DEVd_{TSn} of the information layers.

In FIG. 1 an embodiment of the dual-stack optical data storage medium 10 according to the invention is shown. A focused laser beam 19 with a wavelength λ of 405 nm and an Numerical Aperture (NA) of 0.85 enters through entrance face 16 of the medium 10 during read out. A substrate 11 made of polycarbonate has present on a side thereof:
a first stack of layers 12 named L0 comprising a first information layer, a second stack of layers 13 named L1, comprising a second information layer. L1 is present at a position closest to the entrance face 16 and L0 is present more remote from the entrance face 16 than L1. A transparent spacer layer 14 made of a UV cured resin, e.g. SD 694 made by DIC, is present between L0 and L1. A transparent cover layer 15 is present between the entrance face 16 and L1 and may be made of the same material or a sheet of PC or PMMA with a pressure sensitive adhesive (PSA). The spacer layer may also be a sheet combined with PSA. The transmission stack named TS0 has a thickness d_{TS0} of 100 μm and an effective refractive index n_{TS0}=1.6 and contains all layers between L0 and the entrance face 16. The L1 stack 13 has a relatively low thickness of a maximally a few hundred nm the influence of which may be neglected. Naturally L1 does affect the optical transmission but this aspect is not dealt with here. The transmission stack named TS1 has a thickness d_{TS1} of 80 μm and an effective refractive index n_{TS1} of 1.6 and contains all layers between L1 and the entrance face 16. The stack TS1 corresponds to the cover layer 15. The spacer layer 14 has a thickness of 20 μm. The maximum deviation of d_{TS0} does not exceed a predetermined value DEVd_{TS0} of ±2 μm, measured over the information area of the medium 10. The maximum deviation of d_{TS1} does not exceed a predetermined value DEVd_{TS1} of ±2 μm, measured over the whole area of the medium 10. Thus the wavefront error A40 does not exceed 0.033 λrms.

In FIG. 2 calculations of the wavefront error caused by deviations in the thickness of the cover layer are presented. The graph 21 in the figure corresponds to the calculation for DEV_{TS1} when focusing onto the further information layer of L1, which is situated closer to the entrance face 16 (FIG. 1). Graph 22 corresponds to the calculation for DEV_{TS0} when focusing onto the first information layer of L0, which is situated closer to the substrate 11 of the medium 10 (FIG. 1). As can be seen from this figure, in order to keep the wavefront error rms below 0.033 λ, indicated by the dashed line 23, the deviations in the depth position of the information layer should not exceed ±3 μm. Keeping in mind possible deformations of the medium caused by the manufacturing and working conditions, the deviations should rather be smaller than ±2 μm.

It should be noted that the above-mentioned embodiment illustrates rather than limits the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The mere fact that certain measures are recited in mutually different dependent claims does not indicate that a combination of these measures cannot be used to advantage.

According to the invention a dual-stack optical data storage medium is described for read out using a focused radiation beam with a wavelength λ and a Numerical Aperture NA. The medium has a substrate and a first stack of layers named L0 comprising a first information layer and optionally at least one further stack of layers named Ln, comprising a further information layer. A radiation beam transparent spacer layer is present between each of L0 and Ln. A transmission stack named TS0 with a thickness d_{TS0} contains all layers between L0 and an entrance face of the medium. A transmission stack named TSn with a thickness d_{TSn} contains all layers between Ln and the entrance face. The maximum deviation of d_{TS0} and when applicable d_{TSn} does not exceed a predetermined value DEVd_{TS0} or DEVd_{TSn}, measured over the information area of the medium and this value is set in dependency of λ and NA. In this way a reliable read out of the information layer(s) without the need for dynamic spherical aberration correction is achieved.

1. An optical data storage medium for at least read out using a focused radiation beam with a wavelength λ and a Numerical Aperture (NA), entering through an entrance face of the medium during read out, comprising at least:
a substrate with present on a side thereof:
a first stack of layers named L0 comprising a first information layer,
a radiation beam transparent cover layer adjacent the entrance face,
a transmission stack named TS0 with a thickness d_{TS0} and containing all layers between L0 and the entrance face, characterized in that
the maximum deviation of d_{TS0} from respectively the average values of d_{TS0} of a predetermined area of the medium does not exceed a predetermined value DEVd_{TS0}, measured over the information area of the medium and DEVd_{TS0} is set in dependency of λ and NA.

2. An optical data storage medium according to claim 1, wherein DEVd_{TS0}=±3 μm.

3. An optical data storage medium according to claim 1, with at least
one further stack of layers named Ln and n an integer ≧1, Ln comprising a further information layer and being present at a position closer to the entrance face than L0,
a radiation beam transparent spacer layer between each of L0 to Ln, and
a transmission stack named TSn with a thickness d_{TSn} and containing all layers between Ln and the entrance face, wherein the maximum deviation of d_{TSn} does not exceed a predetermined value DEVd_{TSn}, measured over the information area of the medium and DEVd_{TSn} is set in dependency of λ and NA.

4. An optical data storage medium according to claim 3, wherein DEVd_{TSn}=±3 μm.

5. An optical data storage medium according to claim 1, wherein DEVd_{TS0}=±2 μm.

6. An optical data storage medium according to claim 3, wherein only one further stack of layers named L1 is present, comprising a further information layer, DEVd_{TS0}=±2 μm and DEVd_{TS1}=±2 μm, λ is in the range 400 nm-410 nm and NA is in the range 0.84-0.86.

7. Use of an optical data storage medium as claimed in claim 1 for reliable data read out from at least one information layer.
